(19) United States
(12) Patent Application Publication
(10) Pub. No.: US 2026/0326120 A1
(43) Pub. Date: Oct. 22, 2026

(54) JET NOZZLE AND JET GUN

(71) Applicants: Tyco Electronics (Shanghai) Co., Ltd., Shanghai (CN); TE Connectivity Connectors (Suzhou) Co., Ltd., Suzhou (CN)

(72) Inventors: Jialin Zhang, Shanghai (CN); Changlin (Alex) Wu, Suzhou (CN); Ming Chen, Suzhou (CN); Dan (Nico) Li, Shanghai (CN); Zhongxi Huang, Shanghai (CN); Shawn Zhang, Shanghai (CN)

(73) Assignees: Tyco Electronics (Shanghai) Co., Ltd., Shanghai (CN); TE Connectivity Connectors (Suzhou) Co., Ltd., Suzhou (CN)

(21) Appl. No.: 19/646,672

(22) Filed: Apr. 14, 2026

(30) Foreign Application Priority Data
Apr. 15, 2025 (CN) 202510470869.0

(51) Int. Cl. B05B 1/00; B05B 15/65; F16L 19/07

(52) U.S. Cl. CPC B05B 1/005; B05B 15/65; F16L 19/07

(57) ABSTRACT

A jet nozzle comprises a docking part formed with an insertion hole adapted to receive a jet end of a jet tube of a jet gun, and a jet part arranged in front of the docking part and axially connected to the docking part. The jet part includes a communication hole, an air outlet hole and a suction hole. The air outlet hole extends along an axial direction of the insertion hole. The communication hole axially connects the insertion hole and the air outlet hole. A diameter of the communication hole is smaller than that of the air outlet hole. The suction hole connects the air outlet hole and the external atmosphere formed in the peripheral wall of the jet part. The suction hole has an inlet located on an outer peripheral surface of the jet part. The suction hole extends obliquely forward from its inlet.

### CROSS-REFERENCE TO RELATED APPLICATION

This application claims the benefit of Chinese Patent Application No. CN202510470869.0 filed on Apr. 15, 2025 in the State Intellectual Property Office of China, the whole disclosure of which is incorporated herein by reference.

### FIELD OF THE INVENTION

The present invention relates to a jet nozzle and a jet gun comprising the jet nozzle.

### BACKGROUND OF THE INVENTION

Compressed air blowing can be used in production to quickly clean equipment and workpieces, ensure production quality and efficiency, and provide conveying power in certain application scenarios. In the production process, several typical applications include: using compressed air blowing can effectively remove adsorbed substances on the surface of equipment such as stamping machines, injection molding machines, electroplating lines, assembly machines, etc., keeping the equipment surface clean, helping to extend the service life of the equipment and maintain good operating conditions; Compressed air blowing can quickly remove dust or debris from the surface of products, reduce quality problems caused by it, and avoid potential threats to equipment and products such as dust and debris; In some production lines, lighter materials such as connector plastic shells or semi assembled products can be transported through pipelines or rails. At this time, compressed air blowing can be used to provide power, helping materials flow smoothly in pipelines or tracks without introducing other electrical equipment, achieving efficient and economical transportation.

In the prior art, compressed air blowing spray gun is a simple small mechanism that uses compressed air to achieve the above functions, and is widely used in the production process. Usually, a plastic protective cover is installed on the outlet end of the jet tube of the compressed air blowing spray gun. The purpose of this plastic protective cover is only to avoid accidental injury caused by the sharp end of the jet tube, and cannot achieve energy-saving and efficiency improvement effects.

### SUMMARY OF THE INVENTION

According to an embodiment of the present disclosure, a jet nozzle comprises a docking part formed with an insertion hole adapted to receive a jet end of a jet tube of a jet gun, and a jet part arranged in front of the docking part and axially connected to the docking part. The jet part includes a communication hole, an air outlet hole and a suction hole. The air outlet hole extends along the axial direction of the insertion hole. The communication hole axially connects the insertion hole and the air outlet hole. A diameter of the communication hole is smaller than that of the air outlet hole. The suction hole connects the air outlet hole and the external atmosphere formed in the peripheral wall of the jet part. The suction hole has an inlet located on an outer peripheral surface of the jet part. The suction hole extends obliquely forward from its inlet.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a jet nozzle according to an exemplary first embodiment of the present invention;

FIG. 2 shows an axial cross section view of a jet nozzle according to an exemplary first embodiment of the present invention;

FIG. 3 shows an axial plane cross section view of a jet nozzle according to an exemplary first embodiment of the present invention;

FIG. 4 shows an illustrative view of the docking of the jet tube and jet nozzle of a jet gun according to an exemplary first embodiment of the present invention;

FIG. 5 shows an illustrative view of the docking of the jet tube and jet nozzle of a jet gun according to another exemplary first embodiment of the present invention;

FIG. 6 shows an axial plane cross section view of a jet nozzle according to an exemplary second embodiment of the present invention, wherein the nut has not yet been inserted into the installation part;

FIG. 7 shows an axial plane cross section view of a jet nozzle according to an exemplary second embodiment of the present invention, in which a nut has been inserted into the installation part; and

FIG. 8 shows an illustrative view of the docking of the jet tube and jet nozzle of a jet gun according to an exemplary second embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a jet nozzle comprises a docking part formed with an insertion hole that allows a jet end of a jet tube of a jet gun to be inserted, and a jet part which is located in front of the docking part and is axially connected to the docking part. A communication hole and an air outlet hole extending along the axial direction of the insertion hole are formed in the jet part. The communication hole axially connects the insertion hole and the air outlet hole, and the diameter of the communication hole is smaller than that of the air outlet hole. A suction hole connecting the air outlet hole and the external atmosphere is formed in the peripheral wall of the jet part. The suction hole has an inlet located on the outer peripheral surface of the jet part, the suction hole extends obliquely forward from its inlet.

According to another embodiment of the present disclosure, a jet gun comprises a compressed air generation device used for generating compressed air, a jet tube connected to the compressed air generation device for outputting compressed air, and the above jet nozzle fitted and fixed onto the jet end of the jet tube. The jet end of the jet tube is inserted into the insertion hole of the docking part of the jet nozzle, and the jet hole of the jet tube is docked with the communication hole of the jet nozzle.

### First Embodiment

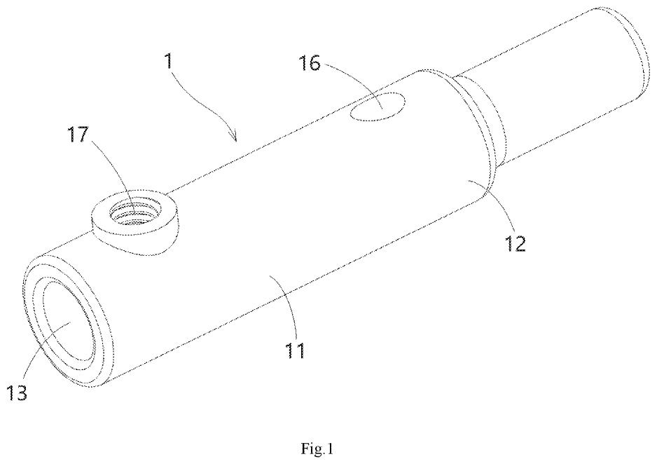

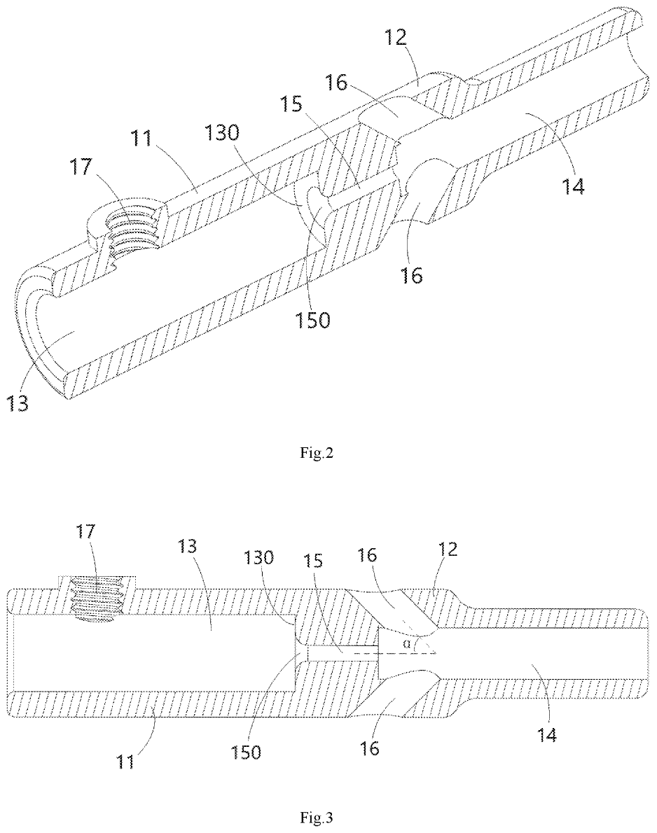

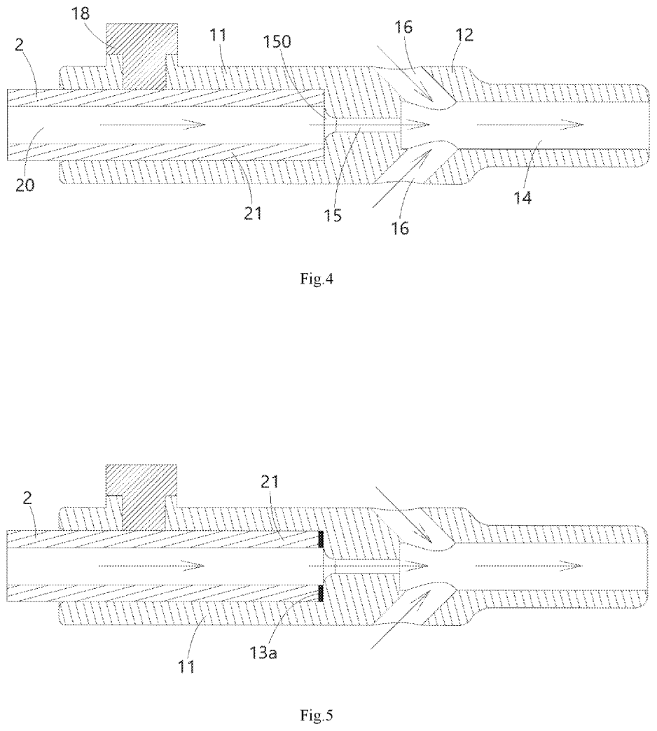

FIGS. 1-5 show the first embodiment according to the present invention. Among them, FIG. 1 shows an illustrative perspective view of a jet nozzle 1 according to an exemplary first embodiment of the present invention. FIG. 2 shows an axial cross section view of a jet nozzle 1 according to an exemplary first embodiment of the present invention. FIG. 3 shows an axial plane cross section view of a jet nozzle 1 according to an exemplary first embodiment of the present invention. FIG. 4 shows an illustrative view of the docking of the jet tube 2 and the jet nozzle 1 of the jet gun according to an exemplary first embodiment of the present invention. FIG. 5 shows an illustrative view of the docking of the jet tube 2 and the jet nozzle 1 of the jet gun according to another exemplary first embodiment of the present invention.

As shown in FIGS. 1-5, in an exemplary embodiment of the present invention, a jet nozzle 1 is disclosed. The jet nozzle 1 includes a docking part 11 and a jet part 12. The docking part 11 is formed with an insertion hole 13 that allows a jet end 21 of a jet tube 2 of a jet gun to be inserted, so that the jet nozzle 1 can be fitted onto the jet end 21 of the jet tube 2 of the jet gun. The jet part 12 is located in front of the docking part 11 and is axially connected to the docking part 11. A communication hole 15 and an air outlet hole 14 extending along the axial direction of the insertion hole 13 are formed in the jet part 12. The communication hole 15 axially connects the insertion hole 13 and the air outlet hole 14, and the diameter of the communication hole 15 is smaller than that of the air outlet hole 14. A suction hole 16 connecting the air outlet hole 14 and the external atmosphere is formed in the peripheral wall of the jet part 12. The suction hole 16 has an inlet located on the outer peripheral surface of the jet part 12, and extends obliquely forward from its inlet.

In the illustrated embodiment, the angle α between the axis of the suction hole 16 and the axis of the communication hole 15 is greater than 10 degrees and less than 70 degrees. For example, the angle α between the axis of the suction hole 16 and the axis of the communication hole 15 can be equal to 10 degrees, 30 degrees, 45 degrees, 60 degrees, 70 degrees, or other suitable angles.

The diameter of the suction hole 16 is smaller than the diameter of the air outlet hole 14 and larger than the diameter of the communication hole 15.

The communication hole 15 has a horn shaped air inlet 150 for docking with the jet hole 20 of the jet tube 2 of the jet gun, and the horn shaped air inlet 150 of the communication hole 15 is flared towards the insertion hole 13. The horn shaped air inlet 150 of the communication hole 15 has a smooth arc-shaped inner surface, which is used to guide the compressed airflow ejected from the jet hole 20 of the jet tube 2 of the jet gun unobstructed into the communication hole 15. The diameter of the communication hole 15, except for the horn shaped air inlet 150, remains constant and equal to the minimum opening diameter of the horn shaped air inlet 150. The maximum opening diameter of the horn shaped air inlet 150 of the communication hole 15 is equal to the diameter of the jet hole 20 of the jet tube 2 of the jet gun. The minimum opening diameter of the horn shaped air inlet 150 is not greater than half of the diameter of the air outlet hole 14, and the maximum opening diameter of the horn shaped air inlet 150 is smaller than the diameter of the air outlet hole 14.

The suction hole 16 has an outlet connected to the air outlet hole 14, and the outlet of the suction hole 16 is adjacent to the outlet of the communication hole 15, so that the compressed airflow ejected from the communication hole 15 and the external atmosphere sucked in from the suction hole 16 can be mixed in the rear end of the air outlet hole 14. In the illustrated embodiment, a pair of suction holes 16 are formed in the peripheral wall of the jet part 12 of the jet nozzle 1, and the pair of suction holes 16 are opposite in the radial direction of the air outlet hole 14. Multiple suction holes 16 are formed in the peripheral wall of the jet part 12 of the jet nozzle 1, and the multiple suction holes 16 are evenly spaced in the circumferential direction of the air outlet hole 14.

As shown in FIGS. 1-5, in the illustrated embodiment, the jet nozzle 1 is an integral 3D printed part or an integral machined part. The jet nozzle 1 can be a metal component or a non-metal component.

The diameter of the insertion hole 13 of the docking part 11 is equal to or slightly larger than the diameter of the jet tube 2 of the jet gun. An annular positioning surface 130 is formed in the insertion hole 13 of the docking part 11 to surround the communication hole 15. The annular positioning surface 130 is perpendicular to the axial direction of the insertion hole 13 and is suitable for axial contact with the end face of the jet end 21 of the jet tube 2 of the jet gun, for axial positioning of the jet tube 2 of the jet gun.

The jet nozzle 1 further comprises an elastic sealing layer 13a, which is formed on the annular positioning surface 130 inside the insertion hole 13 of the docking part 11. The elastic sealing layer 13a is suitable for being axially compressed between the end face of the jet end 21 of the jet tube 2 of the jet gun and the annular positioning surface 130 inside the insertion hole 13 of the docking part 11, to achieve sealing between the jet tube 2 and the jet nozzle 1.

A threaded hole 17 is formed in the peripheral wall of the docking part 11, so that the docking part 11 can be fastened to the jet end 21 of the jet tube 2 of the jet gun through a bolt 18 connected to the threaded hole 17. The jet nozzle 1 also includes a bolt 18. The bolt 18 is threaded with the threaded hole 17. The bolt 18 is suitable to rest against the jet end 21 of the jet tube 2 of the jet gun inserted into the docking part 11, in order to fasten the docking part 11 to the jet end 21 of the jet tube 2 of the jet gun.

Still referring to FIGS. 1-5, in another exemplary embodiment of the present invention, a jet gun is also provided. The jet gun includes a compressed air generation device embodied by a jet tube 2, and the jet nozzle 1. The compressed air generation device is used to generate compressed air. The jet tube 2 is connected to the compressed air generation device for outputting compressed air. The jet nozzle 1 is fitted and fixed onto the jet end 21 of jet tube 2. The jet end 21 of jet tube 2 is inserted into the insertion hole 13 of the docking part 11 of jet nozzle 1, and the jet hole 20 of jet tube 2 is docked with the communication hole 15 of jet nozzle 1. The jet hole 20 of the jet tube 2 of the jet gun is aligned with the maximum opening of the horn shaped air inlet 150 of the communication hole 15 of the jet nozzle 1, and the diameter of the jet hole 20 of the jet tube 2 of the jet gun is equal to the maximum opening diameter of the horn shaped air inlet 150.

### Second Embodiment

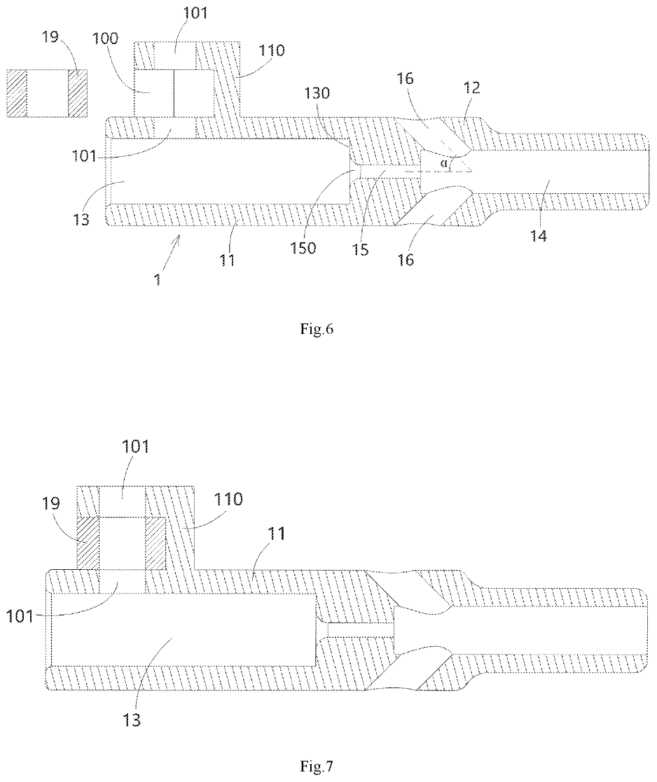

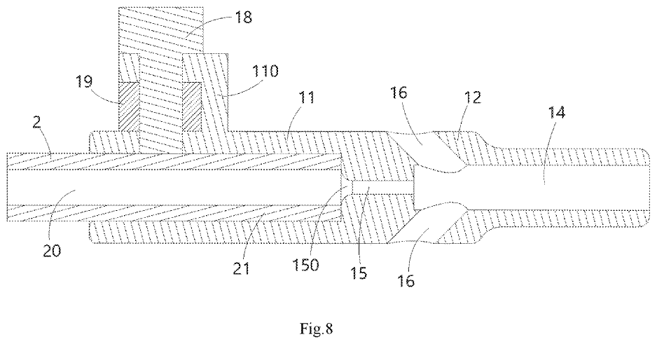

FIGS. 6-8 show a second embodiment according to the present invention. Among them, FIG. 6 shows an axial plane cross section view of the jet nozzle 2 according to an exemplary second embodiment of the present invention, where the nut 19 has not yet been inserted into the installation part 110. FIG. 7 shows an axial plane cross section view of the nozzle 2 according to an exemplary second embodiment of the present invention, in which the nut 19 has been inserted into the installation part 110. FIG. 8 shows an illustrative view of the docking of the jet tube 2 and the jet nozzle 1 of a jet gun according to an exemplary second embodiment of the present invention.

As shown in FIGS. 6-8, in an exemplary embodiment of the present disclosure, a jet nozzle 1 includes a docking part 11 and a jet part 12. The docking part 11 is formed with an insertion hole 13 that allows a jet end 21 of a jet tube 2 of a jet gun to be inserted, so that the jet nozzle 1 can be fitted onto the jet end 21 of the jet tube 2 of the jet gun. The jet part 12 is located in front of the docking part 11 and is axially connected to the docking part 11. A communication hole 15 and an air outlet hole 14 extending along the axial direction of the insertion hole 13 are formed in the jet part 12. The communication hole 15 axially connects the insertion hole 13 and the air outlet hole 14, and the diameter of the communication hole 15 is smaller than that of the air outlet hole 14. A suction hole 16 connecting the air outlet hole 14 and the external atmosphere is formed in the peripheral wall of the jet part 12. The suction hole 16 has an inlet located on the outer peripheral surface of the jet part 12, and extends obliquely forward from its inlet.

In the illustrated embodiment, the angle α between the axis of the suction hole 16 and the axis of the communication hole 15 is greater than 10 degrees and less than 70 degrees. For example, the angle α between the axis of the suction hole 16 and the axis of the communication hole 15 can be equal to 10 degrees, 30 degrees, 45 degrees, 60 degrees, 70 degrees, or other suitable angles.

The diameter of the suction hole 16 is smaller than the diameter of the air outlet hole 14 and larger than the diameter of the communication hole 15. The communication hole 15 has a horn shaped air inlet 150 for docking with the jet hole 20 of the jet tube 2 of the jet gun, and the horn shaped air inlet 150 of the communication hole 15 is flared towards the insertion hole 13. The horn shaped air inlet 150 of the communication hole 15 has a smooth arc-shaped inner surface, which is used to guide the compressed airflow ejected from the jet hole 20 of the jet tube 2 of the jet gun unobstructed into the communication hole 15.

The diameter of the communication hole 15, except for the horn shaped air inlet 150, remains constant and equal to the minimum opening diameter of the horn shaped air inlet 150. The maximum opening diameter of the horn shaped air inlet 150 of the communication hole 15 is equal to the diameter of the jet hole 20 of the jet tube 2 of the jet gun. The minimum opening diameter of the horn shaped air inlet 150 is not greater than half of the diameter of the air outlet hole 14, and the maximum opening diameter of the horn shaped air inlet 150 is smaller than the diameter of the air outlet hole 14. The suction hole 16 has an outlet connected to the air outlet hole 14, and the outlet of the suction hole 16 is adjacent to the outlet of the communication hole 15, so that the compressed airflow ejected from the communication hole 15 and the external atmosphere sucked in from the suction hole 16 can be mixed in the rear end of the air outlet hole 14.

A pair of suction holes 16 are formed in the peripheral wall of the jet part 12 of the jet nozzle 1, and the pair of suction holes 16 are opposite in the radial direction of the air outlet hole 14. Multiple suction holes 16 are formed in the peripheral wall of the jet part 12 of the jet nozzle 1, and the multiple suction holes 16 are evenly spaced in the circumferential direction of the air outlet hole 14.

The jet nozzle 1 is an integral 3D printed part or an integral machined part. The jet nozzle 1 can be a metal component or a non-metal component.

The diameter of the insertion hole 13 of the docking part 11 is equal to or slightly larger than the diameter of the jet tube 2 of the jet gun. An annular positioning surface 130 is formed in the insertion hole 13 of the docking part 11, which surrounds the communication hole 15. The annular positioning surface 130 is perpendicular to the axial direction of the insertion hole 13 and is suitable for axial contact with the end face of the jet end 21 of the jet tube 2 of the jet gun, for axial positioning of the jet tube 2 of the jet gun.

The jet nozzle 1 further includes an elastic sealing layer 13a (see FIG. 5 of the first embodiment), which is formed on the annular positioning surface 130 inside the insertion hole 13 of the docking part 11. The elastic sealing layer 13a is suitable for being axially compressed between the end face of the jet end 21 of the jet tube 2 of the jet gun and the annular positioning surface 130 inside the insertion hole 13 of the docking part 11, to achieve sealing between the jet tube 2 and the jet nozzle 1.

The jet nozzle 1 further comprises an installation part 110 formed outside the peripheral wall of the docking part 11 and having a receiving chamber 100 for mounting and positioning a nut 19. A through hole 101 is formed in the peripheral wall of the docking part 11 to allow a bolt 18 to pass through, so that the docking part 11 can be fastened to the jet end 21 of the jet tube 2 of the jet gun through the bolt 18 threaded with the nut 19 and passing through the through hole 101.

An insertion port is formed on the side of the receiving chamber 100 of the installation part 110 to allow the nut 19 to be inserted, and the through hole 101 is formed in the top wall of the receiving chamber 100 of the installation part 110 to allow the bolt 18 to pass through.

The jet nozzle 1 further comprises a nut 19, which is inserted and positioned into the receiving chamber 100 of the installation part 110 for threaded connection with the bolt 18. The jet nozzle 1 further comprises a bolt 18, which is threaded with the nut 19 and passes through the through-hole 101 in the docking part 11. The bolt 18 is suitable to rest against the jet end 21 of the jet tube 2 of the jet gun inserted into the docking part 11, in order to fasten the docking part 11 to the jet end 21 of the jet tube 2 of the jet gun. In the illustrated embodiment, the outer contour of nut 19 is non-circular, for example, nut 19 is hexagonal. The receiving chamber 100 of the installation part 110 has a non-circular inner contour that matches the outer contour of the nut 19, preventing the nut 19 inserted into the receiving chamber 100 of the installation part 110 from being rotated.

Still referring to FIGS. 6-8, in another exemplary embodiment of the present disclosure, a jet gun is also provided. The jet gun includes a compressed air generation device embodied as a jet tube 2, and the jet nozzle 1. The compressed air generation device is used to generate compressed air. The jet tube 2 is connected to, or is a part of, the compressed air generation device for outputting compressed air. The jet nozzle 1 is fitted and fixed onto the jet end 21 of jet tube 2. The jet end 21 of jet tube 2 is inserted into the insertion hole 13 of the docking part 11 of jet nozzle 1, and the jet hole 20 of jet tube 2 is docked with the communication hole 15 of jet nozzle 1. The jet hole 20 of the jet tube 2 of the jet gun is aligned with the maximum opening of the horn shaped air inlet 150 of the communication hole 15 of the jet nozzle 1. The diameter of the jet hole 20 of the jet tube 2 of the jet gun is equal to the maximum opening diameter of the horn shaped air inlet 150.

Embodiments of the present disclosure aim to significantly improve the utilization efficiency of compressed air by integrating an innovative and energy-saving jet nozzle at its tail end, in order to achieve efficient utilization of compressed air and achieve energy-saving goals. The internal structure of the jet nozzle is formed with a specifically configured flow channel, which can effectively promote the optimization of compressed air flow and achieve significant energy-saving effects. The jet nozzle can be manufactured using 3D printing technology to achieve precise shaping and lightweight of complex structures. For applications that require higher strength, aluminum alloy can be used as the substrate and manufactured through mechanical processing. The jet nozzle design is compatible with standard 6 mm diameter jet tube, making it easy to quickly install and replace the jet nozzle, while providing a certain adjustment range to meet different operational needs. The jet nozzle is designed with a locking structure, which can firmly fasten the jet nozzle to the jet tube of the jet gun, ensuring stability and safety during use.

The jet nozzle of the present invention has the following beneficial technical effects: while maintaining the original blowing effect, it significantly reduces the use of compressed air, thereby reducing the electrical energy consumption and related operating costs of the air compressor; This jet nozzle has good interchangeability with existing jet guns and can be easily replaced without the need for modification. The spare parts replacement process is simple, reducing maintenance difficulty and costs. Through experimental verification, this jet nozzle can reduce compressed air usage by 60% and achieve the same jet speed and pressure as before the jet nozzle was installed.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A jet nozzle, comprising:
a docking part formed with an insertion hole, the insertion hole adapted to receive a jet end of a jet tube of a jet gun; and
a jet part arranged in front of the docking part and axially connected to the docking part, the jet part including:
a communication hole;
an air outlet hole extending along an axial direction of the insertion hole, the communication hole axially connects the insertion hole and the air outlet hole, and a diameter of the communication hole is smaller than that of the air outlet hole; and
a suction hole connecting the air outlet hole and the external atmosphere formed in the peripheral wall of the jet part, the suction hole has an inlet located on an outer peripheral surface of the jet part, the suction hole extends obliquely forward from its inlet.

2. The jet nozzle according to claim 1, wherein an angle between an axis of the suction hole and an axis of the communication hole is greater than 10 degrees and less than 70 degrees.

3. The jet nozzle according to claim 1, wherein a diameter of the suction hole is smaller than a diameter of the air outlet hole and larger than the diameter of the communication hole.

4. The jet nozzle according to claim 1, wherein the communication hole has a horn shaped air inlet for docking with the jet hole of the jet tube of the jet gun, and the horn shaped air inlet of the communication hole is flared towards the insertion hole.

5. The jet nozzle according to claim 4, wherein the horn shaped air inlet of the communication hole has a smooth arc-shaped inner surface adapted to guide a compressed airflow ejected from the jet hole of the jet tube of the jet gun unobstructed into the communication hole.

6. The jet nozzle according to claim 4, wherein a diameter of the other parts of the communication hole except for the horn shaped air inlet remains constant and equal to a minimum opening diameter of the horn shaped air inlet, and a maximum opening diameter of the horn shaped air inlet of the communication hole is equal to a diameter of the jet hole of the jet tube of the jet gun.

7. The jet nozzle according to claim 4, wherein a minimum opening diameter of the horn shaped air inlet is not greater than half of a diameter of the air outlet hole, and a maximum opening diameter of the horn shaped air inlet is smaller than a diameter of the air outlet hole.

8. The jet nozzle according to claim 1, wherein the suction hole has an outlet connected to the air outlet hole, and the outlet of the suction hole is adjacent to the outlet of the communication hole, so that the compressed airflow ejected from the communication hole and the external atmosphere sucked in from the suction hole can mix in the rear end of the air outlet hole.

9. The jet nozzle according to claim 1, wherein a pair of suction holes are formed in a peripheral wall of the jet part of the jet nozzle, and the pair of suction holes are opposite in the radial direction of the air outlet hole.

10. The jet nozzle according to claim 1, wherein multiple suction holes are formed in a peripheral wall of the jet part of the jet nozzle, and the multiple suction holes are evenly spaced in a circumferential direction of the air outlet hole.

11. The jet nozzle according to claim 1, wherein the jet nozzle is an integral 3D printed part or an integral machined part.

12. The jet nozzle according to claim 1, wherein a diameter of the insertion hole of the docking part is equal to or slightly larger than a diameter of the jet tube of the jet gun.

13. The jet nozzle according to claim 1, wherein an annular positioning surface is formed in the insertion hole of the docking par and surrounds the communication hole, the annular positioning surface is perpendicular to the axial direction of the insertion hole and is adapted to axially contact an end face of the jet end of the jet tube of the jet gun, for axial positioning of the jet tube of the jet gun.

14. The jet nozzle according to claim 13, further comprising an elastic sealing layer formed on the annular positioning surface inside the insertion hole of the docking part, the elastic sealing layer adapted to be axially compressed between the end face of the jet end of the jet tube of the jet gun and the annular positioning surface inside the insertion hole of the docking part, to achieve sealing between the jet tube and the jet nozzle.

15. The jet nozzle according to claim 1, wherein a threaded hole is formed in a peripheral wall of the docking part, so that the docking part can be fastened to the jet end of the jet tube of the jet gun through a bolt connected to the threaded hole.

16. The jet nozzle according to claim 15, further comprising a bolt threaded into the threaded hole, the bolt is adapted to rest against the jet end of the jet tube of the jet gun inserted into the docking part, in order to fasten the docking part to the jet end of the jet tube of the jet gun.

17. The jet nozzle according to claim 1, further comprising an installation part formed outside a peripheral wall of the docking part and having a receiving chamber for installing and positioning a nut, a through hole is formed in the peripheral wall of the docking part to allow a bolt to pass through, so that the docking part can be fastened to the jet end of the jet tube of the jet gun through the bolt threaded with the nut and passing through the through hole.

18. The jet nozzle according to claim 17, wherein an insertion port is formed on a side of the receiving chamber of the installation part to allow the nut to be inserted, and the through hole is formed in a top wall of the receiving chamber of the installation part to allow the bolt to pass through.

19. The jet nozzle according to claim 17, further comprising a nut inserted and positioned into the receiving chamber of the installation part for threaded connection with the bolt.

20. The jet nozzle according to claim 19, further comprising a bolt which is threaded with the nut and passes through the through-hole in the docking part, the bolt is adapted to rest against a jet end of the jet tube of the jet gun inserted into the docking part, in order to fasten the docking part to the jet end of the jet tube of the jet gun.

21. The jet nozzle according to claim 19, wherein an outer contour of the nut is non-circular, and the receiving chamber of the installation part has a non-circular inner contour that matches the outer contour of the nut, so that the nut inserted into the receiving chamber of the installation part cannot be rotated.

22. A jet gun, comprising:
a compressed air generation device adapted to generate compressed air;
a jet tube, connected to the compressed air generation device, for outputting compressed air; and
the jet nozzle according to claim 1, fitted and fixed onto the jet end of the jet tube, the jet end of the jet tube is inserted into the insertion hole of the docking part of the jet nozzle, and the jet hole of the jet tube is docked with the communication hole of the jet nozzle.

23. The jet gun according to claim 22, wherein the jet hole of the jet tube of the jet gun is docked with a maximum opening of the horn shaped air inlet of the communication hole of the jet nozzle, and a diameter of the jet hole of the jet tube of the jet gun is equal to the maximum opening diameter of the horn shaped air inlet.
